(19) United States
(12) Patent Application Publication
(10) Pub. No.: US 2022/0194874 A1
(43) Pub. Date: Jun. 23, 2022

(54) UREA FOR TOP DRESSING ENRICHED WITH CALCIUM, MAGNESIUM, SULFUR, AND POTASSIUM

(71) Applicant: SABIC Global Technologies B.V., Bergen op Zoom (NL)

(72) Inventors: Nilkamal BAG, Bangalore (IN); Arvind KUMAR, Bangalore (IN)

(73) Assignee: SABIC Global Technologies B.V., Bergen op Zoom (NL)

(21) Appl. No.: 17/546,526

(22) Filed: Dec. 9, 2021

Related U.S. Application Data
(60) Provisional application No. 63/128,906, filed on Dec. 22, 2020.

(51) Int. Cl. C05G 5/12; C05C 9/00; C05G 1/00; C05D 1/00; C05G 5/30

(52) U.S. Cl. CPC C05G 5/12; C05C 9/005; C05G 5/30; C05D 1/005; C05G 1/00

(57) ABSTRACT

A fertilizer granule containing a homogeneous mixture containing urea in an amount providing 3 to 45 wt. % of nitrogen, sulfate in an amount providing 2 to 25 wt. % of sulfur, 0.1 to 15 wt. % of magnesium, and 0.1 to 25 wt. % of potassium. Methods of making and using the fertilizer granule are also disclosed.

### CROSS REFERENCE TO RELATED APPLICATIONS

This application claims the benefit of priority to U.S. Provisional Patent Application Ser. No. 63/128,906, filed Dec. 22, 2020, hereby incorporated by reference in its entirety.

### BACKGROUND OF THE INVENTION

### A. Field of the Invention

The invention generally concerns urea containing fertilizers. In particular, the invention concerns fertilizer granules containing urea, sulfate, magnesium, potassium, and optionally calcium.

### B. Description of Related Art

To increase crop yield and satisfy the growing needs of an increasing population, more fertilizers are being used in agriculture. However, continuous use of fertilizer can lead to nutrient Unbalance and loss of soil fertility.

Urea is a commonly used nitrogen fertilizer. However, urea nitrogen is volatile and due to its rapid hydrolysis and nitrification in soil, nitrogen from urea can be quickly lost. To counter this effect, urea, for example when applied as a top dressing fertilizer, is applied in a relatively large excess to provide a continuous supply of nitrogen to the plants.

Further depending on the crop and soil type, additional nutrients may also be required for increasing crop yields. However, using urea in fertilizer blends that contain other soil nutrients is difficult, as urea can undesirably react with other components in the fertilizer, such as organic fertilizers. These reactions can produce water that liquefies solid granules or dry mixture products, cause clumping and loss of product, and increase the rate at which these undesirable reactions take place. See Biskupski et al. (EP 2,774,907); see also Achard et al. (U.S. Pat. No. 5,409,516). Further, the production of water increases the amount of water that has to be removed during production of urea containing fertilizers, making these blended fertilizers difficult and more expensive to make. See Schwob (FR 2,684,372).

### SUMMARY OF THE INVENTION

A solution to at least some of the problems discussed above has been discovered. In one aspect, the solution includes providing a fertilizer granule that includes additional nutrients, such as sulfur (S), magnesium (Mg), potassium (K) and optionally calcium (Ca), sourced as metal sulfates, along with urea. It was found that presence of metal sulfates in the granule reduces urea nitrogen volatilization. Multiple nutrients can be provided with a single application by using the fertilizer granules described herein. Further, due to reduced urea nitrogen volatilization, nitrogen utilization efficiency of the fertilizing process can also be increased by using the fertilizer granules described herein.

One aspect of the present invention is directed to a fertilizer granule. The fertilizer granule can contain a homogeneous mixture containing urea, sulfate, magnesium, and potassium. The homogeneous mixture can contain i) urea in an amount providing 3 to 45 wt. % of nitrogen (N), ii) sulfate in an amount providing 2 to 25 wt. % of sulfur (S), iii) 0.1 to 15 wt. % of magnesium (Mg); and iv) 0.1 to 25 wt. % of potassium (K), based on the total weight of the homogeneous mixture. In some aspects, the homogeneous mixture can further contain calcium (Ca). In some particular aspects, the homogeneous mixture can contain 0.1 to 15 wt. % of Ca. The fertilizer granule can be essentially free of an adduct having the formula of CaSO₄.4CO(NH₂)₂. The fertilizer granule can be essentially free of a crystalline adduct having the formula of CaSO₄.4CO(NH₂)₂. The fertilizer granule can have less than 0.1 wt. % of a crystalline adduct having the formula of CaSO₄.4CO(NH₂)₂. The fertilizer granule can have less than 0.1 wt. % of a crystalline adduct having the formula of CaSO₄.4CO(NH₂)₂. In some instances, the fertilizer granule is free of a starch, polysaccharide, and/or other binder. In some instances, the fertilizer granule can have less than 5, 4, 3, 2, 1, 0.5, or 0.1 wt. % of a starch, polysaccharide, binder, or combination thereof.

In some aspects, the homogeneous mixture can be an amorphous or non-crystalline mixture containing urea, sulfate, K, Mg, and optionally Ca. In some aspects, the urea, sulfate, K, Mg, and optionally Ca can be present in a same layer or within a core within the fertilizer granule. In some aspects, the homogeneous mixture can contain 0.4 to 10 wt. % of Mg, 0.5 to 20 wt. % of K, 1 to 11 wt. % of Ca, urea in an amount providing 5 to 41 wt. % of N, and sulfate in an amount providing 5 to 20 wt. % of S, based on the total weight of the mixture.

In some aspects, the i) sulfate, and ii) Mg, K, and/or Ca in the homogeneous mixture can be sourced as one or more sulfates salts. Non-limiting examples of the sulfate salts can include K₂SO₄, CaSO₄, MgSO₄, K₂Ca₂Mg(SO₄)₄, and/or K₂Mg₂(SO₄)₃. In some aspects, the homogeneous mixture can contain a moles of K, b moles of Ca, c moles of Mg, and d moles of S, wherein d is ≥0.9×((a/2)+b+c), where a, c, and d are positive real numbers; b is zero or a positive real number; and a, b, and/or c, are the same or different. In some instances, d is ≥0.95×((a/2)+b+c). In some instances d is ≥0.98×((a/2)+b+c). In some instances, d is ≥0.99×((a/2)+b+c). In some instances, d is equal to ((a/2)+b+c). In some aspects, the sulfate salt can contain sulfate and at least two of Ca, Mg, and K. The homogeneous mixture can optionally contain chlorine (Cl). The homogeneous mixture can optionally contain non-sulfate salts of Ca, Mg, and/or K.

In some aspects, the homogeneous mixture can contain urea and K₂Ca₂Mg(SO₄)₄. In some aspects, the homogeneous mixture can contain crystalline K₂Ca₂Mg(SO₄)₄. In some particular aspects, the homogeneous mixture can be prepared from urea and K₂Ca₂Mg(SO₄)₄. In some particular aspects, the homogeneous mixture can be prepared from urea and K₂Ca₂Mg(SO₄)₄ at a weight ratio of 5:95 to 95:5. In some particular aspects, the homogeneous mixture can be prepared from urea and K₂Ca₂Mg(SO₄)₄ at a weight ratio of about 5:95, 10:90, 20:80, 30:70, 32:68; 40:60, 48:52, 50:50, 58:42, 60:40, 70:30, 72:28; 80:20, 87:13, 90:10, or 95:5. In some instances, the K₂Ca₂Mg(SO₄)₄ is polyhalite and/or poly4 minerals.

In some aspects, the homogeneous mixture can contain urea and K₂Mg₂(SO₄)₃. In some aspects, the homogeneous mixture can contain crystalline K₂Mg₂(SO₄)₃. In some particular aspects, the homogeneous mixture can be prepared from urea and K₂Mg₂(SO₄)₃. In some particular aspects, the homogeneous mixture can be prepared from urea and K₂Mg₂(SO₄)₃ at a weight ratio of 5:95 to 95:5. In some particular aspects, the homogeneous mixture can be prepared from urea and K₂Mg₂(SO₄)₃ at a weight ratio of about 5:95, 10:90, 20:80, 30:70, 32:68; 40:60, 48:52, 50:50, 58:42, 60:40, 70:30, 72:28; 80:20, 87:13, 90:10, or 95:5. In some instances, the K₂Mg₂(SO₄)₃ is langbeinite.

In some aspects, the homogeneous mixture can contain urea, K₂Ca₂Mg(SO₄)₄ and K₂Mg₂(SO₄)₃. In some aspects, the homogeneous mixture can contain crystalline K₂Ca₂Mg(SO₄)₄ and/or crystalline K₂Mg₂(SO₄)₃. In some particular aspects, the homogeneous mixture can be prepared from urea, K₂Ca₂Mg(SO₄)₄, and K₂Mg₂(SO₄)₃. In some particular aspects, the homogeneous mixture can be prepared from urea to K₂Ca₂Mg(SO₄)₄ at a weight ratio of 5:45 to 95:5. In some particular aspects, the homogeneous mixture can be prepared from urea to K₂Mg₂(SO₄)₃ at a weight ratio of 5:45 to 95:5. In some particular aspects, the homogeneous mixture can be prepared from K₂Mg₂(SO₄)₃ to K₂Ca₂Mg(SO₄)₄ weight ratio of 8:10 to 10:8. In some particular aspects, the homogeneous mixture can be prepared from two or three of i) urea to K₂Ca₂Mg(SO₄)₄ at a weight ratio of 5:45 to 95:5; ii) urea to K₂Mg₂(SO₄)₃ at a weight ratio of 5:45 to 95:5; and iii) K₂Mg₂(SO₄)₃ to K₂Ca₂Mg(SO₄)₄ weight ratio of 8:10 to 10:8. In some particular aspects, the homogeneous mixture can be prepared from urea, K₂Ca₂Mg(SO₄)₄, and K₂Mg₂(SO₄)₃ at a weight ratio of 5:47.5:47.5 to 95:2.5:2.5. In some particular aspects, the homogeneous mixture can be prepared from urea, K₂Ca₂Mg(SO₄)₄, and K₂Mg₂(SO₄)₃ at a weight ratio of about 5:47.5:47.5, 10:45:45, 20:40:40, 30:35:35, 40:30:30, 50:25:25, 60:20:20, 70:15:15, 80:10:10, 90:5,5, or 95:2.5:2.5.

The homogeneous mixture can comprise 85 wt. % or greater, 90 wt. % or greater, 95 wt. % or greater, 97 wt. % or greater, or 98 wt. % or greater, or 99 wt. % or greater, or 99.5 wt. % or greater, or about 100 wt. % of the fertilizer granule. Total wt. % of urea, sulfate, K, Mg, and Ca in the homogeneous mixture can be 80 wt. % or greater, 85 wt. % or greater, 90 wt. % or greater, 95 wt. % or greater, or 97 wt. % or greater, or 98 wt. % or greater, or 99 wt. % or greater.

The fertilizer granule can have a urea stability and crushing strength higher than a reference granule containing urea without a metal sulfate. In some aspects, the fertilizer granule can have a crushing strength greater than 2 kg/granule, or equal to or greater than 2.3 kg/granule, or 2.5 kg to 3.5 kg/granule. In some aspects, the fertilizer granule at its widest dimension can be 0.5 to 6 mm, preferably 1 to 5 mm, more preferably 1 to 4 mm.

The fertilizer granule can optionally contain a coat. In certain aspects, the homogeneous mixture can form a core of the fertilizer granule, and the optional coat can form a coating over an outer surface of the core. The coat can cover all or a portion of the core. The coat can contain one or more inhibitors, one or more micronutrients, humic acid, granulation aids, or any combinations thereof. The one or more inhibitors can include an urease inhibitor and/or a nitrification inhibitor. In some instances, the urease inhibitor can be a thiophosphoric triamide derivative or phenyl phosphorodiamidate (PPDA). In some particular instances, the thiophosphoric triamide derivative can be N-(n-butyl) thiophosphoric triamide (NBPT). In some instances, the nitrification inhibitor can be 3,4-dimethylpyrazole phosphate (DMPP), thio-urea (TU), dicyandiamide (DCD), 2-Chloro-6-(trichloromethyl)-pyridine (Nitrapyrin), 5-Ethoxy-3-trichloromethyl-1,2,4-thiadiazol (Terrazole), 2-Amino-4-chloro-6-methyl-pyrimidine (AM), 2-Mercapto-benzothiazole (MBT), or 2-Sulfanimalamidothiazole (ST) or any combinations thereof. In some instances, the nitrification inhibitor can be DCD.

Certain aspects, are directed to a composition containing the fertilizer granule. In some aspects, the fertilizer granule can be included in a fertilizer blend or a compounded fertilizer. The fertilizer blend or the compounded fertilizer in addition to the fertilizer granules can contain a second fertilizer. In some aspects, the second fertilizer can contain urea, monoammonium phosphate (MAP), diammonium phosphate (DAP), muriate of potash (MOP), monopotassium phosphate (MKP), triple super phosphate (TSP), rock phosphate, single super phosphate (SSP), or the like.

One aspect is directed to a method of making a fertilizer granule described herein. The method can include, any one of, any combination of, or all of steps (i), (ii), (iii) and (iv). In step (i), a feed mixture containing urea, Mg, K, sulfate, and optionally Ca can be provided and/or formed. In step (ii), the feed mixture can be contacted with water. In some instances, at least a portion of the water is steam. In some instances, at least a portion of the steam is low pressure steam. The feed mixture can be granulated in the presence of the water to form a wet granulation mixture. In some instances, the feed mixture is granulated in the presence of the steam to form a wet granulated mixture. Step (i) and step (ii) can be performed simultaneously. In step (iii), the wet granulated mixture can be dried to form a heated granulated mixture. In some instances, the wet granulation mixture is dried with a hot air stream. In step (iv), the heated granulated mixture can be cooled to form a cooled granulated mixture containing the fertilizer granule. In some instances, the heated granulation mixture is cooled with an air stream.

The feed mixture can contain i) urea and ii) one or more sulfate salt(s). The sulfate salt(s) can contain i) sulfate, and ii) Mg, K and/or optionally Ca. In some aspects, the sulfate salt(s) can contain at least two of Ca, Mg, and K. In some aspects, the one or more sulfate salt(s) can be selected from CaSO₄, MgSO₄, K₂SO₄, K₂Mg₂(SO₄)₃, and/or K₂Ca₂Mg(SO₄)₄. The salt(s) can be, independently, added in hydrated form or as non-hydrates. The feed mixture can optionally contain K, Mg, and/or Ca that are not or are not from sulfate salts. The feed mixture can optionally contain KCl. In some aspects, the feed mixture can contain urea, CaSO₄, MgSO₄, and/or K₂SO₄. In some aspects, the feed mixture can contain and/or can be prepared by adding urea and K₂Ca₂Mg(SO₄)₄. In some particular aspects, the feed mixture can contain and/or can be prepared by adding urea and K₂Ca₂Mg(SO₄)₄ at a weight ratio of 5:95 to 95:5. In some aspects, K₂Ca₂Mg(SO₄)₄ can be added as polyhalite and/or poly4 minerals. In some aspects, the feed mixture can contain and/or can be prepared by adding urea and K₂Mg₂(SO₄)₃. In some particular aspects, the feed mixture can contain and/or can be prepared by adding urea and K₂Mg₂(SO₄)₃, at a weight ratio of 5:95 to 95:5. In some aspects, K₂Mg₂(SO₄)₃ can be added as langbeinite. In some aspects, the feed mixture can contain and/or can be prepared by adding urea, K₂Ca₂Mg(SO₄)₄, and K₂Mg₂(SO₄)₃. In some particular aspects, the feed mixture can contain and/or can be prepared by adding urea, K₂Ca₂Mg(SO₄)₄, and K₂Mg₂(SO₄)₃, with i) urea to K₂Ca₂Mg(SO₄)₄ weight ratio of 5:45 to 95:5, ii) urea to K₂Mg₂(SO₄)₃ weight ratio of 5:45 to 95:5, and iii) K₂Mg₂(SO₄)₃ to K₂Ca₂Mg(SO₄)₄ weight ratio at a weight ratio of about, or in between any two of 8:10, 9:10, 10:10, 10:9 or 10:8.

The feed mixture can be in a particulate form. In some aspects, prior to granulation, the feed mixture can be ground. In some aspects, the feed mixture is passed through one or more size screens. In some aspects, the feed mixture is blended to obtain a homogeneous feed mixture. In some aspects, the homogeneous feed mixture can have an average particle size of 10 μm to 100 μm. In some aspects, at least a portion of the particles rejected by the one or more size screens can be recycled and mixed with the feed mixture (e.g. feed mixture of a different batch).

In some aspects, the feed mixture can be granulated by an agglomeration process. In the granulation step, the feed mixture can be granulated in presence of water comprised in low pressure steam. In some aspects, the low pressure steam can have a pressure of 3.5 bar to 4.5 bar and/or a temperature of 150° C. to 200° C. In some aspects, the wet granulated mixture can be dried by contact with a hot air stream. The hot air stream can have a temperature of 120° C. to 130° C. In some aspects, the wet granulated mixture can be dried with an air stream that can be an ambient temperature (e.g. 15° C. to 35° C., or 20° C. to 30° C.) air stream. In some aspects, during drying of the wet granulated mixture, the hot air stream/ambient air stream and the wet granulated mixture can have a co-current flow. In some aspects, during cooling of the heated granulated mixture, the heated granulated mixture can be cooled using an air stream. In some instances, the cooling air stream and the heated granulated mixture can have a counter-current flow.

In some aspects, dusts generated during the granulation step (e.g. step ii) and/or drying step (e.g. step iii) can be separated from the atmosphere of the granulation step or drying step using a first dry separator. In some aspects, dusts generated during the cooling step (e.g. step iv) can be separated from the atmosphere of the cooling step using a second dry separator. In some instances, the method uses one or both of either of the first dry separator and/or the second dry separator. In some aspects, the first dry separator can include cyclone separators and/or bag filters. In some aspects, the second dry separator can include cyclone separators and/or bag filters.

One aspect of the present invention is directed to a method of fertilizing, the method comprising applying the fertilizer granule and/or a fertilizer blend containing the fertilizer granule to at least a portion of a soil, a crop, or the soil and the crop. Also disclosed is a method of enhancing plant growth comprising applying to soil, the plant, or the soil and the plant an effective amount of a composition comprising the fertilizer granule and/or the fertilizer blend of the present invention. In certain aspects, the fertilizer granule and/or the fertilizer blend containing the fertilizer granule can be applied to the soil, crop, or soil and crop as a top dressing fertilizer.

Also disclosed are the following Aspects 1 to 20 of the present invention.

Aspect 1 is a fertilizer granule comprising a homogeneous mixture comprising: urea in an amount providing 3 to 45 wt. % of nitrogen (N); sulfate in an amount providing 2 to 25 wt. % of sulfur (S); 0.1 to 15 wt. % of magnesium (Mg); and 0.1 to 25 wt. % of potassium (K), wherein the fertilizer granule is essentially free of a crystalline adduct having the formula of CaSO4.4CO(NH2)2 and wherein the weight percentages are based on the total weight of the homogeneous mixture.

Aspect 2 is the fertilizer granule of aspect 1, wherein the homogeneous mixture further comprises 0.1 to 15 wt. % of calcium (Ca).

Aspect 3 is the fertilizer granule of any one of aspects 1 to 2, wherein the homogeneous mixture comprises 0.4 to 10 wt. % of Mg, 0.5 to 20 wt. % of K, 1 to 11 wt. % of Ca, urea in an amount providing 5 to 41 wt. % of N, and sulfate in an amount providing 5 to 20 wt. % of S.

Aspect 4 is the fertilizer granule of any one of aspects 1 to 3, wherein the homogeneous mixture comprises a moles of K, b moles of Ca, c moles of Mg, and d moles of S, and d is ≥0.9×((a/2)+b+c) and a, b, c, and d are positive real numbers.

Aspect 5 is the fertilizer granule of any one of aspects 1 to 4, wherein the homogeneous mixture comprises a salt comprising: sulfate; and at least two of Ca, Mg, and K.

Aspect 6 is the fertilizer granule of any one of aspects 1 to 5, wherein the homogeneous mixture comprises urea and K2Ca2Mg(SO4)4, and is prepared from urea and K2Ca2Mg(SO4)4 at a weight ratio of 5:95 to 95:5.

Aspect 7 is the fertilizer granule of any one of aspects 1 to 6, wherein the homogeneous mixture comprises urea and K2Mg2(SO4)3, and is prepared from urea and K2Mg2(SO4)3 at a weight ratio of 5:95 to 95:5.

Aspect 8 is the fertilizer granule of any one of aspects 1 to 7, wherein the homogeneous mixture comprises urea, K2Ca2Mg(SO4)4, and K2Mg2(SO4)3, and is prepared from urea, K2Mg2(SO4)3, and K2Ca2Mg(SO4)4, and the K2Mg2(SO4)3 and K2Ca2Mg(SO4)4 are at a weight ratio of 8:10 to 10:8.

Aspect 9 is the fertilizer granule of any one of aspects 1 to 8, having a urea stability and crushing strength higher compared to a reference granule containing urea and free of metal sulfates.

Aspect 10 is the fertilizer granule of any one of aspects 1 to 9, comprising a coat comprising an urease inhibitor, an nitrification inhibitor, a micronutrient, humic acid, and/or granulation aids.

Aspect 11 is a method for making the fertilizer granule of any one of aspects 1 to 10, the method comprising: contacting a feed mixture, said feed mixture comprising, Mg, K, sulfate, urea and optionally Ca, with water and granulating the feed mixture in presence of the low pressure steam to form a wet granulated mixture; drying the wet granulated mixture to form a heated granulated mixture; and cooling the heated granulated mixture to form a cooled granulated mixture comprising the fertilizer granule.

Aspect 12 is the method of aspect 11, wherein dusts generated during the granulation step and/or drying step is separated from the hot air stream using a first dry separator and/or wherein dusts generated during the cooling step is separated from the air stream using a second dry separator.

Aspect 13 is the method of any one of aspects 11 to 12, wherein the feed mixture is in particulate form.

Aspect 14 is the method of any one of aspects 11 to 13, wherein: prior to granulation the feed mixture is ground, passed through one or more size screens, and blended to obtain a homogeneous feed mixture; and the homogeneous feed mixture is granulated in the granulation step.

Aspect 15 is the method of aspect 14, wherein the homogeneous feed mixture has an average particle size of 10 μm to 100 μm.

Aspect 16 is the method of any one of aspects 11 to 15, wherein feed mixture is contacted with water in form of the low pressure steam having a pressure of 3.5 bar to 4.5 bar and/or a temperature of 150° C. to 200° C.

Aspect 17 is the method of any one of aspects 11 to 16, wherein the wet granulated mixture is dried with a hot air stream having a temperature of 120° C. to 130° C., and/or wherein heated granulated mixture is cooled with an air stream.

Aspect 18 is the method of any one of aspects 11 to 17, wherein during drying of the wet granulated mixture, the hot air stream and the wet granulated mixture have a co-current flow, and/or during cooling of the heated granulated mixture, the air stream and the heated granulated mixture have a counter-current flow.

Aspect 19 is the method of any one of aspects 12 to 18, wherein the first dry separator is a first cyclone separator and/or the second dry separator is a second cyclone separator.

Aspect 20 is a method of fertilizing, the method comprising applying a fertilizer granule of any one of aspects 1 to 19 to at least a portion of a soil, a crop, or the soil and the crop.

As used herein, a “reference granule containing urea without a metal sulfate” is a granule that includes the same components, and the same amounts of the components, as the example composition, except that the reference composition does not include metal sulfates. Where a metal sulfate is removed, the wt. % of the removed metal sulfate is added as urea in the reference granule. Thus, if an example fertilizer granule contains 85 wt. % urea, 4 wt. % of CaSO₄, 4 wt. % of MgSO₄, 4 wt. % K₂SO₄, 2.5 wt. % of KCl, and 0.5 wt. % of moisture, a reference granule contains 97 wt. % of urea, 2.5 wt. % of KCl, and 0.5 wt. % of moisture.

In the context of the present invention, fertilizer granules and/or fertilizer blend granules may also be referred to as a particle, granule, fertilizer particle, prill, or fertilizer prill.

The term “fertilizer” is defined as a material applied to soils or to plant tissues to supply one or more plant nutrients essential or beneficial to the growth of plants and/or stimulants or enhancers to increase or enhance plant growth.

The term “granule” can include a solid material. A granule can have a variety of different shapes, non-limiting examples of which include a spherical, a puck, an oval, a rod, an oblong, or a random shape.

The term “particle” can include a solid material less than a millimeter in its largest dimension.

The terms “particulate” or “powder” can include a plurality of particles.

The terms “aqueous based,” “aqueous base,” “water based,” and “water base” are defined as containing water or was previously contained in water before drying.

The terms “about” or “approximately” as used herein are defined as being close to as understood by one of ordinary skill in the art. In one non-limiting embodiment, the terms are defined to be within 10%, preferably within 5%, more preferably within 1%, and most preferably within 0.5%.

The terms “wt. %,” “vol. %,” or “mol. %” refers to a weight, volume, or molar percentage of a component, respectively, based on the total weight, the total volume of material, or total moles, that includes the component. In a non-limiting example, 10 grams of component in 100 grams of the material is 10 wt. % of component.

The term “substantially” and its variations are defined to include ranges within 10%, within 5%, within 1%, or within 0.5%.

The terms “inhibiting” or “reducing” or “preventing” or “avoiding” or any variation of these terms, when used in the claims and/or the specification includes any measurable decrease or complete inhibition to achieve a desired result.

The term “effective,” as that term is used in the specification and/or claims, means adequate to accomplish a desired, expected, or intended result.

The use of the words “a” or “an” when used in conjunction with any of the terms “comprising,” “including,” “containing,” or “having” in the claims, or the specification, may mean “one,” but it is also consistent with the meaning of “one or more,” “at least one,” and “one or more than one.”

The phrase “and/or” can include “and” or “or.” To illustrate, A, B, and/or C can include: A alone, B alone, C alone, a combination of A and B, a combination of A and C, a combination of B and C, or a combination of A, B, and C.

The words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps.

Other objects, features and advantages of the present invention will become apparent from the following figures, detailed description, and examples. It should be understood, however, that the figures, detailed description, and examples, while indicating specific embodiments of the invention, are given by way of illustration only and are not meant to be limiting. Additionally, it is contemplated that changes and modifications within the spirit and scope of the invention will become apparent to those skilled in the art from this detailed description. In further embodiments, features from specific embodiments may be combined with features from other embodiments. For example, features from one embodiment may be combined with features from any of the other embodiments. In further embodiments, additional features may be added to the specific embodiments described herein.

### BRIEF DESCRIPTION OF THE DRAWINGS

Advantages of the present invention may become apparent to those skilled in the art with the benefit of the following detailed description and upon reference to the accompanying drawings. While the invention is susceptible to various modifications and alternative forms, specific embodiments thereof are shown by way of example in the drawings. The drawings may not be to scale.

FIG. 1A) A fertilizer granule according to one example of the present invention. B) A fertilizer granule according to another example of the present invention. FIGS. 1A and 1B show a cross-sectional view, e.g. along a plane perpendicular to a long axis, of the fertilizer granules.

FIGS. 2A and 2B are non-limiting schematics of systems and processes according to two examples of the present invention, for producing a fertilizer granule.

### DETAILED DESCRIPTION OF THE INVENTION

The fertilizer granule of the present invention can contain urea, sulfate, magnesium (Mg), potassium (K), and optionally calcium (Ca). As illustrated in a non-limiting manner in the Examples, it was found that the fertilizer granules of the present invention can have higher urea stability and crushing strength compared to reference granules containing urea without a metal sulfate.

These and other non-limiting aspects of the present invention are discussed in further detail in the following sections.

### A. Fertilizer Granules

The fertilizer granule can contain a homogeneous mixture containing urea, sulfate, magnesium (Mg), potassium (K), and optionally calcium (Ca). In some aspects, the homogeneous mixture can be an amorphous mixture containing the urea, sulfate, Mg, K, and optional Ca. The homogeneous mixture and/or fertilizer granule can contain i) urea in an amount providing 3 to 45 wt. %, or 5 to 41 wt. %, or at least any one of, equal to any one of, or between any two of 3, 5, 10, 15, 20, 25, 30, 35, 40, 41, and 45 wt. % of nitrogen (N), ii) sulfate in an amount providing 2 to 25 wt. %, or 5 to 20 wt. %, or at least any one of, equal to any one of, or between any two of 2, 4, 6, 8, 10, 12, 14, 16, 18, 20, 22, 24. and 25 wt. % of sulfur (S), iii) 0.1 to 15 wt. %, or 0.4 to 10 wt. %, or at least any one of, equal to any one of, or between any two of 0.1, 0.3, 0.4, 0.5, 1, 2, 4, 6, 8, 10, 12, 14, and 15 wt. % of Mg; iv) 0.1 to 25 wt. %, 0.5 wt. % to 20 wt. % or at least any one of, equal to any one of, or between any two of 0.1, 0.5, 1, 2, 4, 6, 8, 10, 12, 14, 16, 18, 20, 22, 24, and 25 wt. % of K, and v) optionally 0.1 to 15 wt. %, or 1 to 11 wt. %, or at least any one of, equal to any one of, or between any two of 0.1, 0.5, 1, 2, 4, 6, 8, 10, 11, 12, 14, and 15 wt. % of Ca, based on the total weight of the homogeneous mixture and/or fertilizer granule respectively. The total wt. % of the combined sulfate, urea, Mg, K, and optionally also including Ca in the homogeneous mixture and/or the fertilizer granule can be 85 wt. % to 100 wt. %, or at least any one of, equal to any one of, or between any two of 85, 86, 87, 88, 89, 90, 91, 92, 93, 94, 95, 96, 97, 98, 99, 99.5, and 100 wt. %, based on the total weight of the homogeneous mixture and/or the fertilizer granule, respectively. Moisture content of the homogeneous mixture and/or the fertilizer granule can be, less than 1 wt. %, preferably 0.7 wt. % or less, such as 0.7 wt. % to 0.5 wt. %, based on the total weight of the homogeneous mixture and/or the fertilizer granule respectively.

The fertilizer granule can be essentially free of, or free of, or contains less than 5 wt. %, or less than 3 wt. %, or less than 1 wt. %, or less than 0.5 wt. %, or less than 0.1 wt. %, of a crystalline adduct having the formula of CaSO₄.4CO(NH₂)₂. In some instances, the fertilizer granule is essentially free of, or free of, or contains less than 5 wt. %, or less than 3 wt. %, or less than 1 wt. %, or less than 0.5 wt. %, or less than 0.1 wt. %, of a starch, polysaccharide, and/or other binder.

In some aspects, the homogeneous mixture can contain i) a moles of K, ii) b moles of Ca, iii) c moles of Mg, and iv) d moles of S, wherein d is ≥0.9×((a/2)+b+c), or ≥0.95×((a/2)+b+c), or ≥0.98×((a/2)+b+c), or ≥0.99×((a/2)+b+c), or ((a/2)+b+c). Where a, c, and d are positive real numbers; b is zero or a positive real number; and a, b, and/or c, are the same or different. In some aspects, 80 wt. % to 100 wt. %, or at least any one of, equal to any one of, or between any two of 80, 81, 82, 83, 84, 85, 86, 87, 88, 89, 90, 91, 92, 93, 94, 95, 96, 97, 98, 99, 99.5, and 100 wt. % of the fertilizer granule can be comprised of the homogeneous mixture.

In some aspects, the Mg, K, and Ca in the homogeneous mixture can be sourced as sulfates. In some aspects, the homogeneous mixture can contain one or more sulfate salts selected from CaSO₄, MgSO₄, K₂SO₄, K₂Mg₂(SO₄)₃, and/or K₂Ca₂Mg(SO₄)₄. The homogeneous mixture can optionally contain Cl. The homogeneous mixture can optionally contain non-sulfate salts of Ca, Mg, and/or K. The homogeneous mixture can optionally contain KCl. In some aspects, the homogeneous mixture can contain and/or can be prepared from urea and K₂Ca₂Mg(SO₄)₄. In some particular aspects, the homogeneous mixture can be prepared from urea and K₂Ca₂Mg(SO₄)₄ at a weight ratio of 5:95 to 95:5, or at least any one of, equal to any one of, or between any two of 5:95, 10:90, 20:80, 30:70, 32:68; 40:60, 48:52, 50:50, 58:42, 60:40, 70:30, 72:28; 80:20, 87:13, 90:10, or 95:5. In some aspects, the homogeneous mixture can contain and/or can be prepared from urea and K₂Mg₂(SO₄)₃. In some particular aspects, the homogeneous mixture can be prepared from urea and K₂Mg₂(SO₄)₃ at a weight ratio of 5:95 to 95:5, or at least any one of, equal to any one of, or between any two of 5:95, 10:90, 20:80, 30:70, 32:68; 40:60, 48:52, 50:50, 58:42, 60:40, 70:30, 72:28; 80:20, 87:13, 90:10, or 95:5.In some aspects, the homogeneous mixture can contain and/or can be prepared from urea, K₂Ca₂Mg(SO₄)₄, and K₂Mg₂(SO₄)₃. In some aspects, the homogeneous mixture can be prepared from urea, K₂Ca₂Mg(SO₄)₄, and K₂Mg₂(SO₄)₃ with i) urea to K₂Ca₂Mg(SO₄)₄ weight ratio of 5:45 to 95:5, or at least any one of, equal to any one of, or between any two of 5:45; 10:45; 20:40; 30:35; 40:30; 50: 25; 60:20; 70:15; 80:10; 90:5 and 95:5, ii) urea to K₂Mg₂(SO₄)₃ weight ratio of 5:45 to 95:5, or at least any one of, equal to any one of, or between any two of 5:45; 10:45; 20:40; 30:35; 40:30; 50: 25; 60:20; 70:15; 80:10; 90:5 and 95:5, and iii) K₂Mg₂(SO₄)₃ to K₂Ca₂Mg(SO₄)₄ weight ratio of 8:10 to 10:8, or at least any one of, equal to any one of, or between any two of 8:10, 9:10, 10:10, 10:9, and 10:8. In some particular aspects, the homogeneous mixture can be prepared from urea, K₂Ca₂Mg(SO₄)₄, and K₂Mg₂(SO₄)₃ at a weight ratio of equal to any one of, or between any two of 5:47.5:47.5, 10:45:45, 20:40:40, 30:35:35, 40:30:30, 50:25:25, 60:20:20, 70:15:15, 80:10:10, 90:5,5, or 95:2.5:2.5.

The fertilizer granule can optionally contain a coat. In certain aspects, the homogeneous mixture can form a core of the fertilizer granule, and the optional coat can form a coating over an outer surface of the core. The coat can contain one or more inhibitors, one or more micronutrients, humic acid, granulation aids, or any combinations thereof. The one or more inhibitors can include an urease inhibitor and/or a nitrification inhibitor. In some aspects, the urease inhibitor can contain a thiophosphoric triamide derivative or phenyl phosphorodiamidate (PPDA). In some particular aspects, the thiophosphoric triamide derivative can be N-(n-butyl) thiophosphoric triamide (NBPT). In some aspects, the nitrification inhibitor can be 3,4-dimethylpyrazole phosphate (DMPP), thio-urea (TU), dicyandiamide (DCD), 2-Chloro-6-(trichloromethyl)-pyridine (Nitrapyrin), 5-Ethoxy-3-trichloromethyl-1,2,4-thiadiazol (Terrazole), 2-Amino-4-chloro-6-methyl-pyrimidine (AM), 2-Mercapto-benzothiazole (MBT), or 2-Sulfanimalamidothiazole (ST) or any combinations thereof, preferably DCD. A micronutrient can be a botanically acceptable form of an inorganic or organometallic compound such as boron, copper, iron, chloride, manganese, molybdenum, nickel, or zinc. Non-limiting examples of granulation aids that can be used includes calcium lignosulfonate, such as calcium lignosulfonate at 0.3 to 0.5 wt. % of the fertilizer granule. The coat can contain one or more coating layers. The coat overall can cover 5 to 100%, or at least any one of, equal to any one of, or between any two of 5, 10, 15, 20, 25, 30, 35, 40, 45, 50, 55, 60, 65, 70, 75, 80, 85, 90, 95, 99, and 100% of an outer surface of the core.

The fertilizer granule can be of any suitable shape. Non-limiting shapes include spherical, cuboidal, cylindrical, puck shape, oval, and oblong shapes. In some aspects, the fertilizer granule can be of cylindrical shape with a circular, elliptical, ovular, triangular, square, rectangular, pentagonal, or hexagonal cross section, although cylindrical shaped core having a cross-section of other shapes can also be made. In some aspects, the fertilizer granule at its widest dimension can be 0.5 mm to 6 mm, or 0.5 mm to 5 mm, preferably 1 mm to 4 mm, or at least any one of, equal to any one of, or between any two of 0.5 mm, 1 mm, 1.5 mm, 2 mm, 2.5 mm, 3 mm, 3.5 mm, 4 mm, 4.5 mm, 5 mm, 5.5 mm, and 6 mm. In some particular aspects, the fertilizer granule can have a substantially spherical shape with an average diameter 0.5 mm to 6 mm, or 0.5 mm to 5 mm, preferably 1 mm to 4 mm, or at least any one of, equal to any one of, or between any two of 0.5 mm, 1 mm, 1.5 mm, 2 mm, 2.5 mm, 3 mm, 3.5 mm, 4 mm, 4.5 mm, 5 mm, 5.5 mm, and 6 mm.

The homogeneous mixture can have a compositional make-up that is substantially homogeneous. In some instances, a compositional make-up for a 0.5 mm×0.5 mm×0.5 mm cube at any position of the mixture can be similar (within ±10%, or ±5%, or ±3%, ±2%, or ±1%, or ±0.5%) to that of a 0.5 mm×0.5 mm×0.5 mm cube at any other position of the mixture.

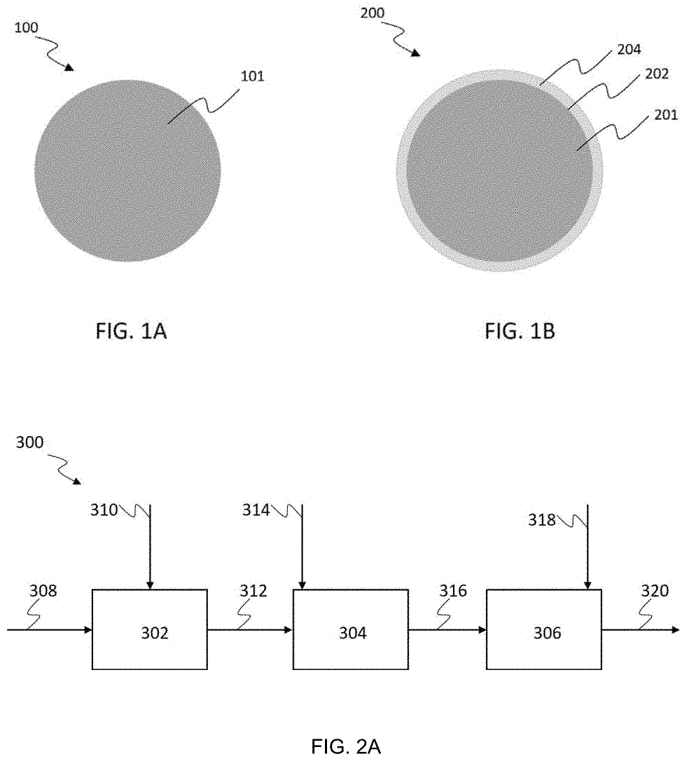

Referring to FIG. 1A, a fertilizer granule 100 according to one example of the present invention is shown. The fertilizer granule 100 can contain an homogeneous mixture 101.

Referring to FIG. 1B, a fertilizer granule 200 according to a second example of the present invention is shown. The fertilizer granule 200 can contain a core 202 and coat 204. The core 202 can contain an homogeneous mixture 201. The coat 204 is represented as covering the entire outer surface of the core 202, although fertilizer granules with the coat 204 covering a portion of the outer surface of the core 202 can readily be made.

The homogeneous mixture 101, 201, and/or coat 202 can have compositions as described above.

In some aspects, additional fertilizer substances can be included or excluded in the fertilizer granules. If included, additional fertilizers can be chosen based on the particular needs of certain types of soil, climate, or other growing conditions to maximize the efficacy of the fertilizer granule in enhancing plant growth and crop yield. Additional additives may also be included or excluded in the fertilizer granules. Non-limiting examples of additives that can be included or excluded from the fertilizer granules of the present invention include micronutrients, additional nitrogen nutrients, and/or additional secondary nutrients. The micronutrient can be boron, copper, iron, chloride, manganese, molybdenum, nickel, or zinc or any combinations thereof. An additional nitrogen nutrient can be a nutrient other than urea, that can deliver nitrogen to a plant. In some aspects, the additional nitrogen nutrient can include ammonium nitrate, ammonium sulfate, diammonium phosphate, monoammonium phosphate, urea-formaldehyde, ammonium chloride, and potassium nitrate. In some aspects, the additional secondary nutrients may include lime, and/or a superphosphate.

The fertilizer granules can have desirable physical properties such as desired levels of abrasion resistance, granule strength, pelletizability, hygroscopicity, granule shape, and size distribution.

The fertilizer granules described herein can be comprised in a composition useful for application to soil. In some aspects, in addition to the fertilizer granules, the composition may include other fertilizer compounds, micronutrients, primary nutrients, additional urea, additional nitrogen nutrients, insecticides, herbicides, or fungicides, or combinations thereof.

The fertilizer granules described herein can also be included in a blended composition comprising other fertilizers. The other fertilizer can be monoammonium phosphate (MAP), diammonium phosphate (DAP), muriate of potash (MOP), monopotassium phosphate (MKP), triple super phosphate (TSP), rock phosphate, single super phosphate (SSP), ammonium sulfate, and the like.

### B. Method of Making a Fertilizer Granule

One aspect of the present invention is directed to a method for making a fertilizer granule, such as a fertilizer granule described herein.

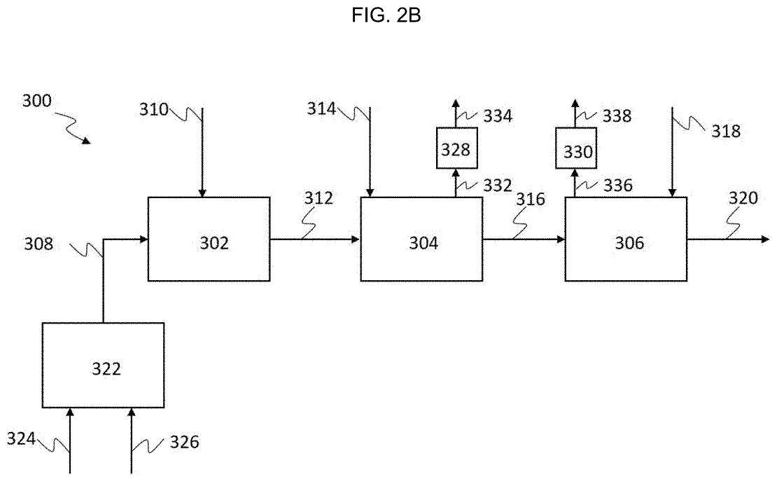

Referring to FIGS. 2A and 2B, systems and methods for producing a fertilizer granule according to two examples are described. The system 300 can include a granulator 302, a dryer 304, and a cooler 306. A feed 308 containing urea, sulfate, Mg, K, and optionally Ca, and a low pressure steam 310 can be fed to the granulator 302. In the granulator, the feed 308 can be contacted with the low pressure steam 310 and can be granulated to form a wet granulated mixture 312. The wet granulated mixture 312 from the granulator 302, and a hot air stream 314 can be fed to the dryer 304. In the dryer 304 the wet granulated mixture 312 can be dried in presence of the hot air stream 314 to form a heated granulated mixture 316. In certain aspects, the wet granulated mixture 312 and the hot air stream 314 can have co-current flow in the dryer 304. The heated granulated mixture 316 from the dryer 304, and an air stream 318 can be fed to the cooler 306. In the cooler 306 the heated granulated mixture 316 can be cooled in the presence of the air 318 to form a cooled granulated mixture 320 containing the fertilizer granule.

In certain aspects, particles having a size larger or smaller than a desired size can be separated from the heated granulated mixture 316 and/or the cooled granulated mixture 320. In some instances, at least a portion of the separated particles can be recycled back to the granulator 302. Particles having a size larger than the desired size can be crushed and/or ground prior to feeding to the granulator. The desired size for the heated granulated mixture can be same or different than the cooled granulated mixture.

Referring to FIG. 2B in certain aspects, the system can further contain a mixing and grinding unit 322, a first dry separator 328, and a second dry separator 330. Urea 324 and one or more sulfate salt(s) 326 can be fed to the mixing and grinding unit 322. The one or more sulfate salt(s) can contain (e.g. independently) K, Mg, and/or Ca. In the unit 322, urea and the one or more sulfate salt(s) can be ground, passed through one or more size screens, and mixed to form a homogeneous feed mixture 308. The homogeneous feed mixture 308 from the mixing and grinding unit 322 can be fed to the granulator 302. In certain aspects, dusts generated during the granulation step (e.g. in the granulator 302) and/or in the drying step (e.g. in the dryer 304), can be removed using the first dry separator 328. A dust containing stream 332 from the dryer 304 can be passed through the first dry separator 328. In the first dry separator 328 the dusts from stream 332 can be captured. In some aspects, a stream 334 from the first dry separator 328 containing residual dust materials can be passed through a scrubber solution to capture at least a portion of the residual dusts (not shown). In some aspects, the first dry separator 328 can include cyclone separators and/or bag filters. In certain aspects, dusts generated during the cooling step (e.g. in the cooler 306) can be removed with the second dry separator 330. A dust containing stream 336 from the cooler 306 can be passed through the second dry separator 330. In the second dry separator 330 dusts from stream 336 can be captured. In some aspects, a stream 338 from the second dry separator 330 containing residual dust materials can be passed through a scrubber solution to capture at least a portion of the residual dusts (not shown). In some aspects, the second dry separator can include cyclone separators and/or bag filters.

In certain aspects, the homogeneous feed mixture, wet granulated mixture, heated granulated mixture, and/or cooled granulated mixture can be coated with a coat containing one or more of inhibitors, one or more of micronutrients, humic acid, granulation aids, or any combinations thereof.

The homogeneous feed mixture 308 can contain i) urea and ii) the one or more sulfate salt(s). In some aspects, the sulfate salt(s) can be a mixed salt containing sulfate and at least two of Ca, Mg, and K. In some aspects, the one or more sulfate salt(s) can be selected from CaSO₄, MgSO₄, K₂SO₄, K₂Mg₂(SO₄)₃, and/or K₂Ca₂Mg(SO₄)₄. The salt(s) can be added, independently, as a hydrate or a non-hydrate. The feed mixture 308 can optionally contain non-sulfate salts of K, Mg, and/or Ca. The feed mixture 308 can optionally contain KCl. In some aspects, the feed mixture can contain urea, CaSO₄, MgSO₄, and/or K₂SO₄. In some aspects, the feed mixture can contain and/or can be prepared by adding urea and K₂Ca₂Mg(SO₄)₄. In some particular aspects, the feed mixture can contain and/or can be prepared by adding urea and K₂Ca₂Mg(SO₄)₄ at a weight ratio of 5:95 to 95:5, or at least any one of, equal to any one of, or between any two of 5:95, 10:90, 15:85, 20:80, 25:75, 30:70, 32:68, 35:65, 40:60, 45:55, 50:50, 55:45, 58:42, 60:40, 65:35, 70:30, 72:28, 75:25, 80:20, 85:15, 87:13, 90:10, and 95:5. In some aspects, K₂Ca₂Mg(SO₄)₄ can be added as polyhalite and/or poly4 minerals. In some aspects, the feed mixture 308 can contain and/or can be prepared by adding urea and K₂Mg₂(SO₄)₃. In some particular aspects, the feed mixture can contain and/or can be prepared by adding urea and K₂Mg₂(SO₄)₃ at a weight ratio of 5:95 to 95:5 or at least any one of, equal to any one of, or between any two of 5:95, 10:90, 15:85, 20:80, 25:75, 30:70, 32:68, 35:65, 40:60, 45:55, 48:52, 50:50, 55:45, 58:42, 60:40, 65:35, 70:30, 72:28, 75:25, 80:20, 85:15, 87:13, 90:10, and 95:5. In some aspects, K₂Mg₂(SO₄)₃ can be added as langbeinite. In some aspects, the feed mixture can contain and/or can be prepared by adding urea, K₂Ca₂Mg(SO₄)₄, and K₂Mg₂(SO₄)₃. In some particular aspects, the feed mixture can contain and/or can be prepared by adding urea, K₂Ca₂Mg(SO₄)₄, and K₂Mg₂(SO₄)₃, with i) urea to K₂Ca₂Mg(SO₄)₄ weight ratio of 5:45 to 95:5, or at least any one of, equal to any one of, or between any two of 5:45; 10:45; 20:40; 30:35; 40:30; 50:25; 60:20; 70:15; 80:10; 90:5 and 95:5, ii) urea to K₂Mg₂(SO₄)₃ weight ratio of 5:45 to 95:5, or at least any one of, equal to any one of, or between any two of 5:45; 10:45; 20:40; 30:35; 40:30; 50:25; 60:20; 70:15; 80:10; 90:5 and 95:5, and iii) K₂Mg₂(SO₄)₃ to K₂Ca₂Mg(SO₄)₄ weight ratio of 8:10 to 10:8, or at least any one of, equal to any one of, or between any two of 8:10, 9:10, 10:10, 10:9, and 10:8. In some particular aspects, the homogeneous mixture can be prepared from urea, K₂Ca₂Mg(SO₄)₄, and K₂Mg₂(SO₄)₃ at a weight ratio of equal to any one of, or between any two of 5:47.5:47.5, 10:45:45, 20:40:40, 30:35:35, 40:30:30, 50:25:25, 60:20:20, 70:15:15, 80:10:10, 90:5,5, or 95:2.5:2.5. The homogeneous feed mixture 308 can have an average particle size of 10 μm to 100 μm, or at least any one of, equal to any one of, or between any two of 10, 20, 30, 40, 50, 60, 70, 80, 90, and 100 μm.

The homogeneous feed mixture can have a compositional make-up that is substantially homogeneous, and a compositional make-up for a 0.5 mm×0.5 mm×0.5 mm cube at any position of the mixture can be similar (e.g. within ±10%, or ±5%, or ±3%, ±2%, or ±1%, or ±0.5%) to that of a 0.5 mm×0.5 mm×0.5 mm cube at any other position of the mixture.

In some aspects, the granulator 302 can be a drum granulator, pugmill, or a pan granulator. In some particular aspects, the granulator 302 can be a rotatory drum granulator. In the granulator 302, the homogeneous feed mixture can be granulated at a temperature of 70 to 100° C., such as 80 to 85° C. and/or pressure of 0.75 to 1.15× the atmospheric pressure, such as at atmospheric pressure. In some aspects, the homogeneous feed mixture can be granulated by an agglomeration process. The low pressure steam 310 can have a temperature of 150° C. to 200° C., or at least any one of, equal to any one of, or between any two of 150, 160, 170, 180, 190, and 200° C. and/or a pressure of 3.5 bar to 4.5 bar or at least any one of, equal to any one of, or between any two of 3.5, 3.7, 3.9, 4, 4.1, 4.3 and 4.5 bar. In some aspects, during drying of the wet granulated mixture, the hot air stream and the wet granulated mixture can have a co-current flow. A co-current hot air flow in the dryer can take out moisture along with dry granules in same direction, and may decrease moisture concentration inside the dryer.

In some aspects, the dryer 304 can be a rotary dryer. The hot air stream 314 can have a temperature of 120° C. to 130° C., or at least any one of, equal to any one of, or between any two of 120, 121, 122, 123, 124, 125, 126, 127, 128, 129, and 130° C.

In some aspects, the cooler 306 can be a rotary cooler. The air stream 318 can be an ambient temperature (e.g. 15° C. to 40° C., or 20° C. to 30° C.) air stream. In some aspects, during cooling of the heated granulated mixture, the air stream and the heated granulated mixture can have a counter-current flow.

Conventionally, dusts generated during fertilizer granulation is removed by using acidified water. After dust removal the acidified water contains plant nutrients. To recover valuable nutrients, the acidified is recycled and added to the granulation step. However, only a portion of the used acidified water can be recycled, and a major portion of the water goes to waste or sold as a reduced value product. Use of the cyclone separators and/or bag filters, e.g., the first dry separator and/or the second dry separator, allows the methods of the present invention to optionally eliminate or reduce use of acid water to remove dusts.

### C. Methods of Using Fertilizer Granules

The fertilizer granule(s), fertilizer composition(s) containing the fertilizer granule(s), and/or fertilizer blends(s) containing the fertilizer granule(s) described herein can be used in methods of increasing the amount of nitrogen, sulfur, Mg, K, and optionally Ca in soil and of enhancing plant growth. Such methods can include applying to the soil an effective amount of a composition comprising the fertilizer granule(s) described herein. The method may include increasing the growth and yield of crops, trees, ornamentals, etc., such as, for example, palm, coconut, rice, wheat, corn, barley, oats, and soybeans. The method can include applying the fertilizer blend of the present invention to at least one of a soil, an organism, a liquid carrier, a liquid solvent, etc. In certain aspects, the composition(s) and/or fertilizer blends(s) containing the fertilizer granule(s) can be applied as a top dressing fertilizer.

Non-limiting examples of plants that can benefit from the fertilizer of the present invention include vines, trees, shrubs, stalked plants, ferns, etc. The plants may include orchard crops, vines, ornamental plants, food crops, timber, and harvested plants. The plants may include Gymnosperms, Angiosperms, and/or Pteridophytes. The Gymnosperms may include plants from the Araucariaceae, Cupressaceae, Pinaceae, Podocarpaceae, Sciadopitaceae, Taxaceae, Cycadaceae, and Ginkgoaceae families. The Angiosperms may include plants from the Aceraceae, Agavaceae, Anacardiaceae, Annonaceae, Apocynaceae, Aquifoliaceae, Araliaceae, Arecaceae, Asphodelaceae, Asteraceae, Berberidaceae, Betulaceae, Bignoniaceae, Bombacaceae, Boraginaceae, Burseraceae, Buxaceae, Canellaceae, Cannabaceae, Capparidaceae, Caprifoliaceae, Caricaceae, Casuarinaceae, Celastraceae, Cercidiphyllaceae, Chrysobalanaceae, Clusiaceae, Combretaceae, Cornaceae, Cyrillaceae, Davidsoniaceae, Ebenaceae, Elaeagnaceae, Ericaceae, Euphorbiaceae, Fabaceae, Fagaceae, Grossulariaceae, Hamamelidaceae, Hippocastanaceae, Illiciaceae, Juglandaceae, Lauraceae, Lecythidaceae, Lythraceae, Magnoliaceae, Malpighiaceae, Malvaceae, Melastomataceae, Meliaceae, Moraceae, Moringaceae, Muntingiaceae, Myoporaceae, Myricaceae, Myrsinaceae, Myrtaceae, Nothofagaceae, Nyctaginaceae, Nyssaceae, Olacaceae, Oleaceae, Oxalidaceae, Pandanaceae, Papaveraceae, Phyllanthaceae, Pittosporaceae, Platanaceae, Poaceae, Polygonaceae, Proteaceae, Punicaceae, Rhamnaceae, Rhizophoraceae, Rosaceae, Rubiaceae, Rutaceae, Salicaceae, Sapindaceae, Sapotaceae, Simaroubaceae, Solanaceae, Staphyleaceae, Sterculiaceae, Strelitziaceae, Styracaceae, Surianaceae, S ymplocaceae, Tamaricaceae, Theaceae, Theophrastaceae, Thymelaeaceae, Tiliaceae, Ulmaceae, Verbenaceae, and/or Vitaceae family.

The effectiveness of compositions comprising the fertilizer granule(s) of the present invention can be ascertained by measuring the amount of nitrogen in the soil at various times after applying the fertilizer composition to the soil. It is understood that different soils have different characteristics, which can affect the stability of the nitrogen in the soil. The effectiveness of a fertilizer composition can also be directly compared to other fertilizer compositions by doing a side-by-side comparison in the same soil under the same conditions.

### EXAMPLES

The present invention will be described in greater detail by way of specific examples. The following examples are offered for illustrative purposes only, and are not intended to limit the invention in any manner. Those of skill in the art will readily recognize a variety of noncritical parameters which can be changed or modified to yield essentially the same results.

### Example 1

### Fertilizer Granules Containing Urea and Polyhalite

Methods: Urea and polyhalite from individual hoppers were batched according to weight ratios provided in Table 1, to form feed mixtures. Ten sets, 1-10, of feed mixtures were formed. For each set, the N, S, Mg, K, and Ca wt. % in the feed mixtures and in the granulated fertilizer compositions (e.g. containing fertilizer granules) produced, is provided in Table 1. For each set, the feed mixture was crushed by a crusher and passed through screens to obtain a feed mixture of uniform size. The feed mixture was mixed thoroughly to form a homogeneous feed mixture and was then fed to a rotary drum steam granulator. In the rotary drum steam granulator granules were formed by an agglomeration process. Low pressure steam was fed to the granulator, and was contacted with the mixture being granulated. From the granulator the material was fed to a rotary dryer. A co-current hot air flow was used for drying in the dryer. The hot air for drying was produced in a hot air generator. From the dryer the material was fed to a vibrating feeder to separate lumps, and then the material was fed to a first screen. Air from the dryer was passed through cyclone separators and bag filters to remove dust materials. Desired product material from the first screen was fed to a rotary cooler. Material in the rotary cooler was cooled with ambient air having an counter-current flow. Air from the cooler was passed through cyclone separators and bag filters to remove dust materials. After the cooler, the material was then fed to a series of screens where the fines were separated from the product mixture, and the separated fines were recycled back to the granulator. The average recycling rate was about 50%.

The average crushing strength of the fertilizer granules for each of the sets, 1-10, was greater than 2.5 kg/granule, with an average of 2.8 kg/granule. The crushing strength of a reference granule containing urea without a metal sulfate, produced using similar method steps as above, e.g. for sets 1-10, was around 2 kg/granule. The granules were spherical shaped with an average product size of >4 mm for 5% of the granules produced, 1-4 mm for 94.3% of the granules produced, and <1 mm for 0.7% of the granules produced.

TABLE 1
Fertilizers produced from urea and polyhalite.

| Set | Urea | Polyhalite | N | K₂O | S | Mg | Ca |
|---|---|---|---|---|---|---|---|
| # | (wt. %) | (wt. %) | (wt. %) | (wt. %) | (wt. %) | (wt. %) | (wt. %) |
| 1 | 10 | 90 | 5 | 13 | 17 | 3 | 11 |
| 2 | 20 | 80 | 9 | 11 | 15 | 3 | 10 |
| 3 | 32 | 68 | 15 | 10 | 13 | 2 | 8 |
| 4 | 40 | 60 | 18 | 8 | 11 | 2 | 7 |
| 5 | 50 | 50 | 23 | 7 | 10 | 2 | 6 |
| 6 | 58 | 42 | 27 | 6 | 8 | 1 | 5 |
| 7 | 72 | 28 | 33 | 4 | 5 | 1 | 3 |
| 8 | 80 | 20 | 37 | 3 | 4 | 1 | 2 |
| 9 | 90 | 10 | 41 | 1 | 2 | 0.4 | 1 |
| 10 | 87 | 13 | 40 | 2 | 2 | 0.5 | 2 |

### Example 2

### Fertilizer Granules Containing Urea and Langbenite

Methods: Urea and langbeinite from individual hoppers were batched according to weight ratios provided in Table 2 to form feed mixtures. Ten sets, 11-20, of feed mixtures were formed. For each set, the N, S, Mg, and K, wt. % in the feed mixtures and in the granulated fertilizer compositions (e.g. containing fertilizer granules) produced, is provided in Table 2. For each set, granulated fertilizer compositions were produced from the feed mixtures according to methods similar to Example 1. Average crushing strength of the fertilizer granules for each of the sets, 11-20, were greater than 2.5 kg/granule, with an average of 2.8 kg/granule. The crushing strength of a reference granule containing urea without a metal sulfate, produced using similar method steps as above, e.g. for sets 1-10, was around 2 kg/granule. The granules were spherical shaped with an average product size of >4 mm for 5% of the granules produced, 1-4 mm for 94.3% of the granules produced, and <1 mm for 0.7% of the granules produced.

TABLE 2
Fertilizers produced from urea and langbeinite.

| Set | Urea | Langbeinite | N | K₂O | S | Mg |
|---|---|---|---|---|---|---|
| # | (wt. %) | (wt. %) | (wt. %) | (wt. %) | (wt. %) | (wt. %) |
| 11 | 10 | 90 | 5 | 20 | 20 | 10 |
| 12 | 20 | 80 | 9 | 18 | 18 | 9 |
| 13 | 32 | 68 | 15 | 15 | 15 | 7 |
| 14 | 40 | 60 | 18 | 13 | 13 | 7 |
| 15 | 48 | 52 | 22 | 11 | 11 | 6 |
| 16 | 58 | 42 | 27 | 9 | 9 | 5 |
| 17 | 72 | 28 | 33 | 6 | 6 | 3 |
| 18 | 80 | 20 | 37 | 4 | 4 | 2 |
| 19 | 90 | 10 | 41 | 2 | 2 | 1 |
| 20 | 87 | 13 | 40 | 3 | 3 | 1 |

### Example 3

### Fertilizer Granules Containing Urea, Polyhalite, and Langbenite

Methods: Urea, polyhalite, and langbeinite from individual hoppers were batched according to weight ratios provided in Table 3 to form feed mixtures. Nine sets, 21-29, of feed mixtures were formed. For each set, the N, S, Mg, K and Ca, wt. % in the feed mixtures and in the granulated fertilizer compositions (e.g. containing fertilizer granules) produced, is provided in Table 3. For each set, granulated fertilizer compositions were produced from the feed mixtures according to methods similar to Example 1. Average crushing strength of the fertilizer granules for each of the sets, 21-29, were greater than 2.5 kg/granule, with an average of 2.8 kg/granule. The crushing strength of a reference granule containing urea without a metal sulfate, produced using similar method steps as above, e.g. for sets 1-10, was around 2 kg/granule. The granules were spherical shaped with an average product size of >4 mm for 5% of the granules produced, 1-4 mm for 94.3% of the granules produced, and <1 mm for 0.7% of the granules produced.

TABLE 3
Fertilizers produced from urea, polyhalite and langbeinite.

| Set | Urea | Polyhalite | Langbenite | N | K₂O | S | Mg | Ca |
|---|---|---|---|---|---|---|---|---|
| # | (wt. %) | (wt. %) | (wt. %) | (wt. %) | (wt. %) | (wt. %) | (wt. %) | (wt. %) |
| 21 | 10 | 45 | 45 | 5 | 16 | 18 | 7 | 5 |
| 22 | 20 | 40 | 40 | 9 | 14 | 16 | 6 | 5 |
| 23 | 30 | 35 | 35 | 14 | 13 | 14 | 5 | 4 |
| 24 | 40 | 30 | 30 | 18 | 11 | 12 | 4 | 4 |
| 25 | 50 | 25 | 25 | 23 | 9 | 10 | 4 | 3 |
| 26 | 60 | 20 | 20 | 28 | 7 | 8 | 3 | 2 |
| 27 | 70 | 15 | 15 | 32 | 5 | 6 | 2 | 2 |
| 28 | 80 | 10 | 10 | 37 | 4 | 4 | 1 | 1 |
| 29 | 90 | 5 | 5 | 41 | 2 | 2 | 1 | 1 |

### Example 4

### Characterization of the Fertilizer Granules

Chemical analysis for chemical content of the fertilizer granules can be determined by methods known in the art. As non-limiting examples, nitrogen content can be determined by the Total Nitrogen in Fertilizer by Combustion Technique described in AOAC official Method 993.13.1996 (AOAC International). Calcium content can be determined by the Calcium by Atomic Absorption Spectrometric Method described in ISO 10084, 1992 (International Organization for Standardization). Sulfur content can be determined by the Gravimetric Barium Sulfate Method described in ISO 10084, 1992 (International Organization for Standardization).

The purity of the components can be cross-checked by NMR, HPLC, and LCMS analysis.

Granule size can be determined using standard sieve test methods. The granules are expected to be able to be produced in any size required for fertilizer applications, such as spherical granules having a diameter of between 5 mm and 5 cm.

Crush strength can be determined by a commercial compression tester (Chatillon Compression Tester). Individual granules between 2 to 4 mm in diameter can be placed on a mounted flat (stainless steel) surface and pressure applied by a flat-end rod (stainless steel) attached to the compression tester. A gauge mounted in the compression tester can measure the pressure (in kilograms) required to fracture the granule. At least 25 granules can be tested and the average of these measurements can be taken as the crush strength. (Ref. method #IFDC S-115 Manual for determining physical properties of fertilizer-IFDC 1993). It is expected that the formulation will have an acceptable crush strength (>2 kgf/granule).

The stability in soil and/or water, release rates, nitrogen volatilization, and nitrogen transformation (nitrification) can be measured in different soils and/or water and compared to other fertilizers and to products on the market. A soil that is representative of a broader class of soil types can be used to measure the properties of the fertilizer. Greenville soil and Crowley soil are two such representative soils. Other soils may also be used for the experiments described herein.

Nitrogen volatilization can be determined as the percentage of nitrogen loss via ammonia volatilization as compared to the amount of nitrogen applied or as the absolute mass of nitrogen lost via ammonia volatilization.

Benefits to crops can be determined and compared to other fertilizers and to products on the market. Non-limiting properties of the crop that can be tested include growth rate, root mass, head size, fruit size, grain size and mass, number of plants, number of fruits or grains, date to maturity, drought tolerance, heat and cold tolerance, yield, etc.

Surface and cross-sectional morphology of the fertilizer granule of the present invention can be carried out using a scanning electron microscope (SEM). These morphology studies can be used to determine the properties of a coated or uncoated fertilizer of the present invention.

1. A fertilizer granule comprising a homogeneous mixture comprising:
urea in an amount providing 3 to 45 wt. % of nitrogen (N);
sulfate in an amount providing 2 to 25 wt. % of sulfur (S);
0.1 to 15 wt. % of magnesium (Mg); and
0.1 to 25 wt. % of potassium (K),
wherein the fertilizer granule is essentially free of a crystalline adduct having the formula of CaSO₄.4CO(NH₂)₂ and wherein the weight percentages are based on the total weight of the homogeneous mixture.

2. The fertilizer granule of claim 1, wherein the homogeneous mixture further comprises 0.1 to 15 wt. % of calcium (Ca).

3. The fertilizer granule of claim 1, wherein the homogeneous mixture comprises 0.4 to 10 wt. % of Mg, 0.5 to 20 wt. % of K, 1 to 11 wt. % of Ca, urea in an amount providing 5 to 41 wt. % of N, and sulfate in an amount providing 5 to 20 wt. % of S.

4. The fertilizer granule of claim 1, wherein the homogeneous mixture comprises a moles of K, b moles of Ca, c moles of Mg, and d moles of S, and d is ≥0.9×((a/2)+b+c) and a, b, c, and d are positive real numbers.

5. The fertilizer granule of claim 1, wherein the homogeneous mixture comprises a salt comprising:
sulfate; and
at least two of Ca, Mg, and K.

6. The fertilizer granule of claim 1, wherein the homogeneous mixture comprises urea and K₂Ca₂Mg(SO₄)₄, and is prepared from urea and K₂Ca₂Mg(SO₄)₄ at a weight ratio of 5:95 to 95:5.

7. The fertilizer granule of claim 1, wherein the homogeneous mixture comprises urea and K₂Mg₂(SO₄)₃, and is prepared from urea and K₂Mg₂(SO₄)₃ at a weight ratio of 5:95 to 95:5.

8. The fertilizer granule of claim 1, wherein the homogeneous mixture comprises urea, K₂Ca₂Mg(SO₄)₄, and K₂Mg₂(SO₄)₃, and is prepared from urea, K₂Mg₂(SO₄)₃, and K₂Ca₂Mg(SO₄)₄, and the K₂Mg₂(SO₄)₃ and K₂Ca₂Mg(SO₄)₄ are at a weight ratio of 8:10 to 10:8.

9. The fertilizer granule of claim 1, having a urea stability and crushing strength higher compared to a reference granule containing urea and free of metal sulfates.

10. The fertilizer granule of claim 1, comprising a coat comprising an urease inhibitor, an nitrification inhibitor, a micronutrient, humic acid, and/or granulation aids.

11. A method for making the fertilizer granule of claim 1, the method comprising:
contacting a feed mixture, said feed mixture comprising, Mg, K, sulfate, urea and optionally Ca, with water and granulating the feed mixture in presence of the low pressure steam to form a wet granulated mixture;
drying the wet granulated mixture to form a heated granulated mixture; and
cooling the heated granulated mixture to form a cooled granulated mixture comprising the fertilizer granule.

12. The method of claim 11, wherein dusts generated during the granulation step and/or drying step is separated from the hot air stream using a first dry separator and/or wherein dusts generated during the cooling step is separated from the air stream using a second dry separator.

13. The method of claim 11, wherein the feed mixture is in particulate form.

14. The method of claim 11, wherein:
prior to granulation the feed mixture is ground, passed through one or more size screens, and blended to obtain a homogeneous feed mixture; and
the homogeneous feed mixture is granulated in the granulation step.

15. The method of claim 14, wherein the homogeneous feed mixture has an average particle size of 10 μm to 100 μm.

16. The method of claim 11, wherein feed mixture is contacted with water in form of the low pressure steam having a pressure of 3.5 bar to 4.5 bar and/or a temperature of 150° C. to 200° C.

17. The method of claim 11, wherein the wet granulated mixture is dried with a hot air stream having a temperature of 120° C. to 130° C., and/or wherein heated granulated mixture is cooled with an air stream.

18. The method of claim 11, wherein during drying of the wet granulated mixture, the hot air stream and the wet granulated mixture have a co-current flow, and/or during cooling of the heated granulated mixture, the air stream and the heated granulated mixture have a counter-current flow.

19. The method of claim 12, wherein the first dry separator is a first cyclone separator and/or the second dry separator is a second cyclone separator.

20. A method of fertilizing, the method comprising applying a fertilizer granule of claim 1 to at least a portion of a soil, a crop, or the soil and the crop.
